(19) United States
(12) Patent Application Publication
(10) Pub. No.: US 2021/0364067 A1
(43) Pub. Date: Nov. 25, 2021

(54) Pulley Mount

(71) Applicant: Andra Coleman, Dallas, TX (US)

(72) Inventor: Andra Coleman, Dallas, TX (US)

(21) Appl. No.: 17/316,843

(22) Filed: May 11, 2021

Related U.S. Application Data
(60) Provisional application No. 63/028,663, filed on May 22, 2020.

(51) Int. Cl. F16H 7/20; F16G 11/04

(52) U.S. Cl. CPC F16H 7/20; F16H 2007/185; F16G 11/04

(57) ABSTRACT

A pulley mount is provided. The device includes a crossbar having a pair of support arms extending from a front side of the crossbar, wherein the pair of support arms are disposed at an angle such that a distance between a distal end of each support arm is less than a distance between a proximal end of each support arm. A pulley is rotatably affixed between the distal ends of each support arm. A brace support extends from a lower side of each of the pair of support arms, wherein a brace extends perpendicularly between the brace supports. In some embodiments, the brace support is telescopically adjustable in length. A recess is disposed within the crossbar. A plurality of teeth extends from each lateral side of the recess.

### CROSS REFERENCE TO RELATED APPLICATIONS

This application claims the benefit of U.S. Provisional Application No. 63/028,663 filed on May 22, 2020. The above identified patent application is herein incorporated by reference in its entirety to provide continuity of disclosure.

### BACKGROUND OF THE INVENTION

The present invention relates to pulley systems. More particularly, the present invention pertains to a pulley mount system securable to a railing or other support surface and further includes a plurality of teeth to secure a rope or cable at a desired height.

Many individuals struggle with hauling various items up and down flights of stairs during the moving process. Alternatively, when an individual purchases a large or bulky object, such as groceries, it can be difficult to carry that object up several flights of stairs to arrive at the target location. Particularly, movers must often transport a dolly or other bulky transport tool repeatedly up and down several flights of stairs, which can be exhausting and time-consuming. Repeated trips can lead to increased risk of injury and extended resting periods, which can result in a prolonged moving process. In some cases, several additional movers or other individuals may be required to transport various items to and from an elevated level of an apartment building in a reasonable timeframe. Therefore, a device that can reduce the effort required to move objects between levels of a building to minimize the number of laden trips up and down flights of stairs is desired.

In light of the devices disclosed in the known art, it is submitted that the present invention substantially diverges in design elements from the known art and consequently it is clear that there is a need in the art for an improvement to existing pulley systems. In this regard, the instant invention substantially fulfills these needs.

### SUMMARY OF THE INVENTION

In view of the foregoing disadvantages inherent in the known types of pulley systems now present in the known art, the present invention provides a pulley mount wherein the same can be utilized for providing convenience for the user when lifting various items between floors.

The present system comprises a crossbar having a pair of support arms extending from a front side of the crossbar, wherein the pair of support arms are disposed at an angle such that a distance between a distal end of each support arm is less than a distance between a proximal end of each support arm. A pulley is rotatably affixed between the distal ends of each support arm. A brace support extends from a lower side of each of the pair of support arms, wherein a brace extends perpendicularly between the brace supports. In some embodiments, the brace supports are telescopically adjustable in length. A recess is disposed within the crossbar, wherein a plurality of teeth extends from each lateral side of the recess.

In some embodiments, a notch extends longitudinally along a lower end of the crossbar, wherein the notch removably secures the crossbar to a support surface. In another embodiment, a front edge of the notch is coplanar with a rear side of the brace. In other embodiments, the brace comprises a length equivalent to a length of the crossbar. In yet another embodiment, the distal end of each of the pair of support arms is disposed perpendicular to the crossbar. In some embodiments, each of the brace supports is disposed perpendicular to the crossbar. In another embodiment, each tooth of the plurality of teeth includes a rounded tip. In other embodiments, each tooth of the plurality of teeth comprises a high-friction material. In yet another embodiment, the recess is coaxially aligned with a groove of the pulley. In some embodiments, each brace support comprises a first section having a plurality of apertures on opposing lateral sides thereof, wherein the plurality of apertures frictionally engages a plurality of pin detents disposed on opposing lateral sides of a second section of each brace support.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the pulley mount.

FIG. 2 shows a side view of an embodiment of the pulley mount.

FIG. 3 shows a top-down view of an embodiment of the pulley mount.

FIG. 4 shows a close-up view of an embodiment of the pulley mount.

FIG. 5 shows a perspective view of an embodiment of the pulley mount in use.

### DETAILED DESCRIPTION OF THE INVENTION

Reference is made herein to the attached drawings. Like reference numerals are used throughout the drawings to depict like or similar elements of the pulley mount. The figures are intended for representative purposes only and should not be considered to be limiting in any respect.

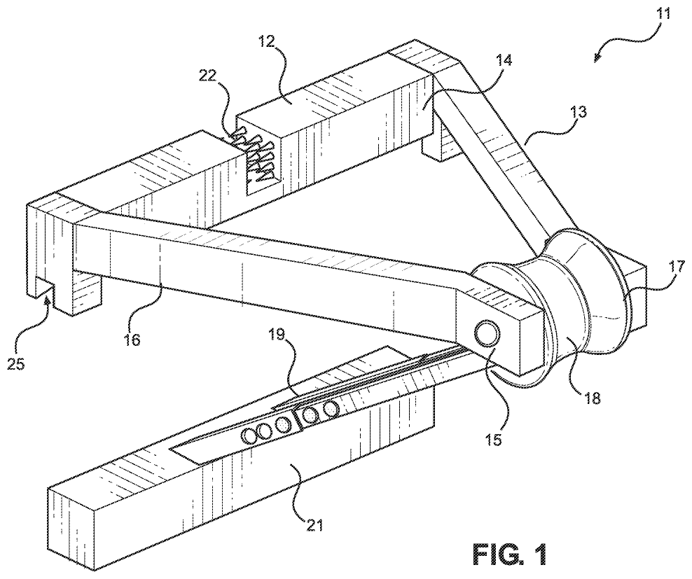

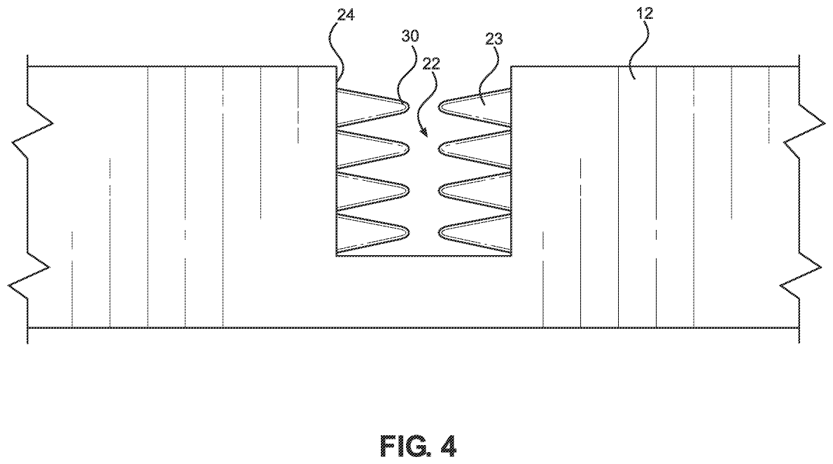

Referring now to FIG. 1, there is shown a perspective view of an embodiment of the pulley mount. The pulley mount 11 comprises a crossbar 12 having a pair of support arms 13 extending from a front side 14 of the crossbar 12. The pair of support arms 13 extend from the front side 14 at an angle such that a linear distance between a distal end 15 of each support arm 13 is less than a linear distance between a proximal end 16 of each support arm 13. A pulley 17 is rotatably affixed to each of the pair of support arms 13 between the distal ends 15 thereof. In the illustrated embodiment, a groove 18 is disposed about a circumference of the pulley 17, wherein the groove 18 is dimensioned to retain a rope of cable therein. In this manner, the user can seat a rope or cable within the groove 18 and extend the rope over the crossbar 12 to allow an item secured to an end of the rope to be raised or lowered between levels of a building. In the illustrated embodiment, a recess 22 is disposed within the crossbar 12, wherein the recess 22 includes a plurality of teeth (as shown in FIG. 4, 23) therein. In the shown embodiment, the recess 22 is disposed centrally on the crossbar 12 and aligned with the pulley 17 such that the rope can be secured within the recess 22 to prevent the rope from dropping from a desired height.

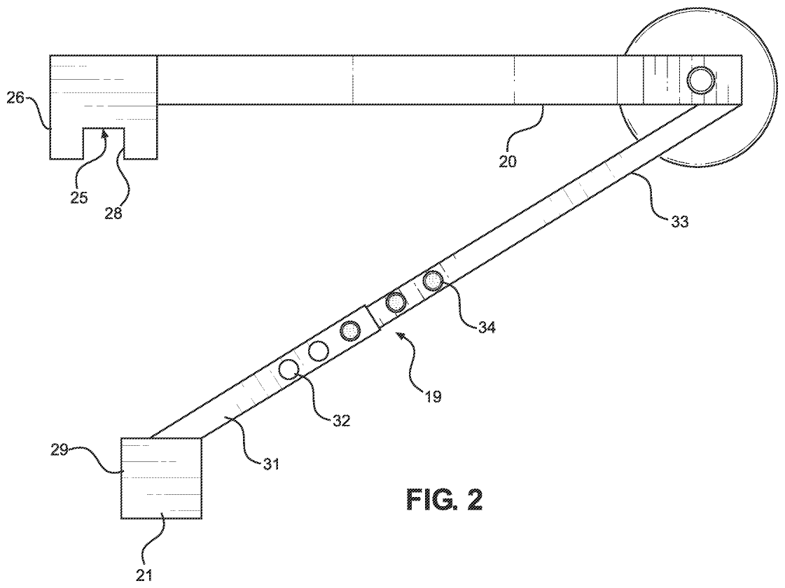

In the illustrated embodiment, a notch 25 is disposed on a lower end (as shown in FIG. 2, 26) of the crossbar 12, wherein the notch 25 is configured to removably secure the pulley mount 11 to a support surface, such as a wall or railing. The notch 25 is disposed such that a longitudinal axis of the notch 25 is parallel to a longitudinal axis of the crossbar 12. A pair of brace supports 19 extend from a lower side (as shown in FIG. 2, 20) of the pair of support arms 13. In the shown embodiment, the pair of brace supports 19 extend rearwardly towards the crossbar 12. A brace 21 extends between a terminal end of each of the pair of brace supports 19, wherein the brace 21 is oriented parallel to the crossbar 12 to rest against a front face of the support surface to ensure the pulley 17 remains elevated away from the support surface during use.

Referring now to FIG. 2, there is shown a side view of an embodiment of the pulley mount. In the illustrated embodiment, the notch 25 is defined between a pair of planar members affixed to the lower end 26 of the crossbar. In some embodiments, the notch 25 extends along an entirety of the lower end 26 to increase the surface area in contact with the support surface during use. In some embodiments, a front edge 28 of the notch 25 is disposed in coplanar alignment with a rear side 29 of the brace 21, such that the brace 21 rests flush against a front face of a planar support surface disposed within the notch 25. As such, in some embodiments, the pair of brace supports 19 extending from the lower side 20 of the pair of support arms are dimensioned to align the rear side 29 of the brace 21 with the front edge 28 of the notch 25. Alternatively, in the illustrated embodiment, the pair of brace supports 19 are telescopically adjustable in length, wherein each of the brace supports 19 comprises a first section 31 slidably disposed over a second section 33. In the shown embodiment, the second section 33 includes a plurality of pin detents 34 on opposing sides thereof, wherein the plurality of pin detents 34 are configured to extend through a plurality of apertures 32 disposed through opposing sides of the first section 31. In this manner, the user can selectively adjust the position of the brace 21 to accommodate support surfaces of various configurations, thereby ensuring that the rear side 29 of the brace 21 properly supports the pulley mount.

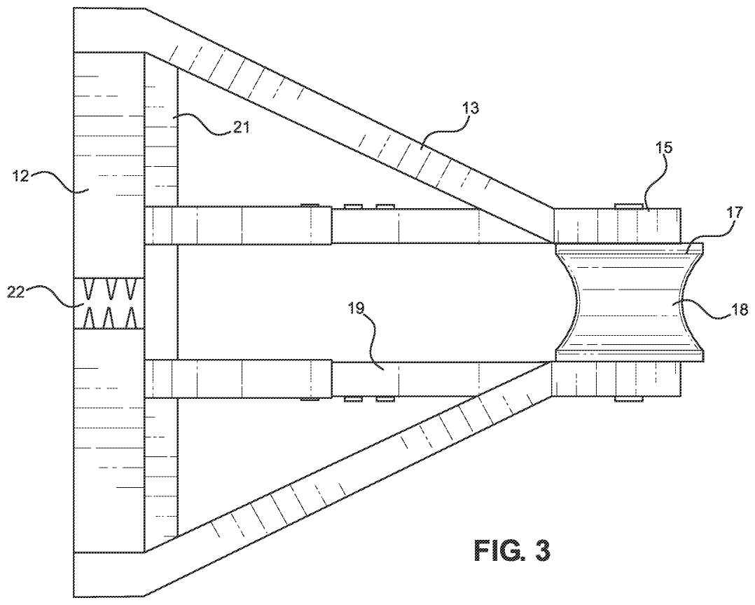

Referring now to FIG. 3, there is shown a top-down view of an embodiment of the pulley mount. As shown in the illustrated embodiment, the crossbar 12 is disposed parallel to the brace 21, allowing the brace 21 to rest flush against the support surface secured to the crossbar 12 via the notch. Furthermore, in the shown embodiment, the pair of brace supports 19 are disposed perpendicular to the brace 21 to distribute loads from the pulley 17 directly into the front face of the support surface via the brace 21. Additionally, the orientation of the various elements ensures that the structural stability of the pulley mount is maximized. In the illustrated embodiment, the distal ends 15 of the pair of support arms 13 are disposed perpendicularly relative to the crossbar 12, such that the pulley 17 is disposed therebetween. Furthermore, in the illustrated embodiment, the recess 22 is disposed in linear alignment with the groove 18 of the pulley 17. In this manner, the rope is maintained in a perpendicular orientation relative to the crossbar 12 when stowed within the recess 22 to reduce the risk of the rope becoming unseated from the groove 18 due to angular shifts.

Referring now to FIG. 4, there is shown a close-up view of an embodiment of the pulley mount. In the illustrated embodiment, the recess 22 within the crossbar 12 includes a plurality of teeth 23 extending from each lateral side 24 of the recess 22, such that an interior volume of the recess 22 is reduced thereby. The plurality of teeth 23 are dimensioned to reduce a distance between the lateral sides 24 such that a diameter of a rope is greater than a distance between the plurality of teeth 23. In this manner, the plurality of teeth 23 frictionally engage the rope therebetween to prevent the rope from moving along the pulley when not desired. In some embodiments, the plurality of teeth 23 comprise a high friction material, such as a rubber coating, thereon, wherein the high friction material is contemplated to increase frictional engagement between the plurality of teeth 23 and the rope. In some embodiments, the high friction material comprises a coating over the plurality of teeth 23, however, in alternate embodiments, the plurality of teeth 23 are composed entirely of the high friction material, such as rubber, to increase flexibility of the plurality of teeth 23 and increase frictional engagement with the rope. In the illustrated embodiment, the plurality of teeth 23 further comprise rounded tip 30, wherein the rounded tip 30 is configured to minimize damage to the rope caused by retention between the plurality of teeth 23.

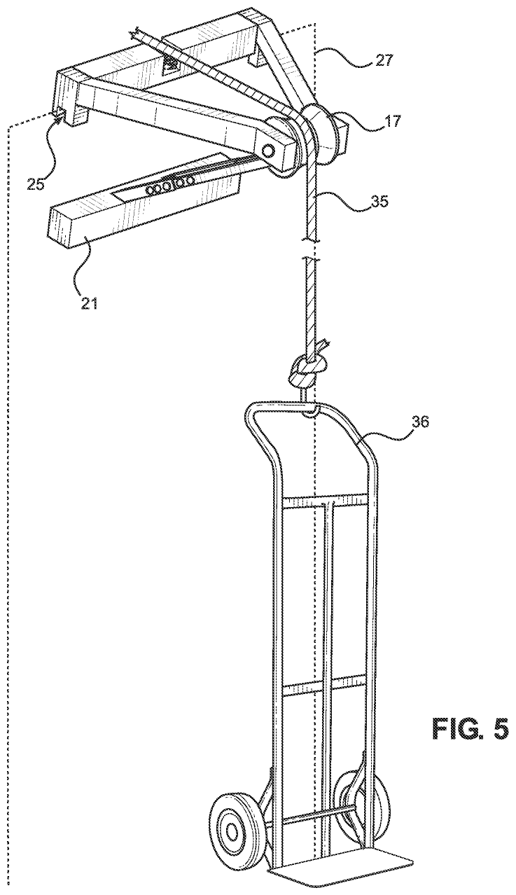

Referring now to FIG. 5, there is shown a perspective view of an embodiment of the pulley mount in use. In one use, the pulley mount is secured to a support surface 27 such as a wall or stairwell railing via the notch 25. In the shown embodiment, the brace 21 is then positioned to rest against the front face of the support surface 27. In some embodiments, the pair of brace supports can be adjusted in length to ensure that the brace 21 is properly positioned against the support surface 27. Once secured to the support surface 27, the user can engage the rope 35 with the pulley 17, such that the rope 35 can be raised or lowered by the user. An end of the rope 35 can then be secured to an object 36, such as a dolly or other device that must be moved between levels of a building. In some embodiments, the distal end of the rope 35 includes a connector thereon, such as a hook, wherein the connector is configured to removably secure the object 36 thereto. The user can then pull the rope 35 to raise the object 36. Once raised to a desired height, or in the case of the user requiring a rest, the rope 35 can be secured within the recess disposed on the crossbar of the pulley mount. Once secured, the rope 35 is retained in the current position, allowing the user to rest or retrieve the object 36. In this manner, the user can readily raise and lower an object 36 between levels of a building without requiring the user to carry the object 36 while traversing several flights of stairs.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A pulley mount, comprising:
a crossbar having a pair of support arms extending from a front side of the crossbar;
wherein the pair of support arms are disposed at an angle such that a distance between a distal end of each support arm is less than a distance between a proximal end of each support arm;
a pulley rotatably affixed between the distal ends of each support arm;
a brace support extending from a lower side of each of the pair of support arms, wherein a brace extends perpendicularly between the brace supports;
a recess disposed within the crossbar;
a plurality of teeth extending from each lateral side of the recess.

2. The pulley mount of claim 1, a notch extending longitudinally along a lower end of the crossbar, wherein the notch removably secures the crossbar to a support surface.

3. The pulley mount of claim 2, wherein a front edge of the notch is coplanar with a rear side of the brace.

4. The pulley mount of claim 1, wherein the brace comprises a length equivalent to a length of the crossbar.

5. The pulley mount of claim 1, wherein the distal end of each of the pair of support arms is disposed perpendicular to the crossbar.

6. The pulley mount of claim 1, wherein each of the brace supports is disposed perpendicular to the crossbar.

7. The pulley mount of claim 1, wherein each tooth of the plurality of teeth includes a rounded tip.

8. The pulley mount of claim 1, wherein each tooth of the plurality of teeth comprises a high-friction material.

9. The pulley mount of claim 1, wherein the recess is coaxially aligned with a groove of the pulley.

10. A pulley mount, comprising:
a crossbar having a pair of support arms extending from a front side of the crossbar;
wherein the pair of support arms are disposed at an angle such that a distance between a distal end of each support arm is less than a distance between a proximal end of each support arm;
a pulley rotatably affixed between the distal ends of each support arm;
a brace support extending from a lower side of each of the pair of support arms, wherein a brace extends perpendicularly between the brace supports;
wherein each brace support is telescopically adjustable in length;
a recess disposed within the crossbar;
a plurality of teeth extending from each lateral side of the recess.

11. The pulley mount of claim 10, a notch extending longitudinally along a lower end of the crossbar, wherein the notch removably secures the crossbar to a support surface.

12. The pulley mount of claim 11, wherein a front edge of the notch is coplanar with a rear side of the brace.

13. The pulley mount of claim 10, wherein the brace comprises a length equivalent to a length of the crossbar.

14. The pulley mount of claim 10, wherein the distal end of each of the pair of support arms is disposed perpendicular to the crossbar.

15. The pulley mount of claim 10, wherein each of the brace supports is disposed perpendicular to the crossbar.

16. The pulley mount of claim 10, wherein each tooth of the plurality of teeth includes a rounded tip.

17. The pulley mount of claim 10, wherein each tooth of the plurality of teeth comprises a high-friction material.

18. The pulley mount of claim 10, wherein the recess is coaxially aligned with a groove of the pulley.

19. The pulley mount of claim 10, wherein each brace support comprises a first section having a plurality of apertures on opposing lateral sides thereof, wherein the plurality of apertures frictionally engages a plurality of pin detents disposed on opposing lateral sides of a second section of each brace support.
